(19) United States
(12) Patent Application Publication
(10) Pub. No.: US 2003/0085169 A1
(43) Pub. Date: May 8, 2003

(54) Filter cartridge with divided filter bed for gravity-flow use

(76) Inventor: Roger P. Reid, Caldwell, ID (US)

Correspondence Address: PEDERSEN & COMPANY, PLLC, P.O. BOX 2666, BOISE, ID, 83701, US

(21) Appl. No.: 10/280,887

(22) Filed: Oct. 24, 2002

Related U.S. Application Data
(60) Provisional application No. 60/343,802, filed on Oct. 24, 2001.

(51) Int. Cl. B01D 35/027

(52) U.S. Cl. 210/435; 210/448; 210/473

(57) ABSTRACT

A liquid filter or cartridge is disclosed, in which the filter bed is divided into multiple, parallel filter beds in a single filter housing. The divided bed system is preferably used for granular media such as activated carbon that is slightly hydrophobic. This compartmentalization of media into separate beds improves media utilization, which results in higher efficiency filtration/treatment and longer filter life, compared to a conventional single-compartment filter in the same outer housing. Preferably, many compartment walls are disposed axially in a gravity-flow or other low-pressure-condition filter, and media is loaded in-between all the walls. Water flows into and through each separate bed before exiting the filter, and each bed has a small diameter, and low bed diameter to bed length ratio, compared to the overall filter housing diameter and ratio, thus, providing a plurality of beds that encourage a high percentage of the media in each separate bed to be wet and to perform filtration.

This application claims priority of our prior, co-pending provisional patent application, Serial 60/343,802, filed on Oct. 24, 2001, entitled “Filter Cartridge with Divided Filter Bed for Gravity-Flow Use,” which is incorporated herein by reference.

### BACKGROUND OF THE INVENTION

1. Field of the Invention

This invention relates to filters and filter cartridges for low-pressure applications, such as gravity-flow water filtration in home and office settings.

2. Related Art

Various filters for low-pressure filtration are available on the market for installation in water pitchers, water canisters, or water-bottle devices. These devices are popular in homes and offices for providing filtered drinking and cooking water. Such devices provide for water flow under very low pressure, for example, less than 15 psi. Often such devices operate under gravity-flow conditions, wherein a reservoir of water is provided above the filter, and the water flows down through the filter and to a filtered-water reservoir below the filter.

Traditionally, instructions accompanying such filters include a step to pre-wet the filter, by soaking the filter in clean water for a specified period of time. This pre-wetting step aims at wetting the media contained in the filter, which is often a carbon or carbon-based media that is slightly hydrophobic. This pre-wetting is intended to wet the media before use for encouraging water-to-media contact during use, and, thus, to increase the media's effectiveness in removing metals, chlorine, or other contaminants over a longer filter life.

Even after a “pre-wet” procedure, conventional filter media in these gravity-flow devices is only partially made wet, or partially “wetted-out” as it is called. This results in filter performance and filter life that are reduced below the theoretical maximum, because only a portion of the filter media, in effect, is being used for filtration.

Therefore, there is a need for an improved filter for gravity-flow/low-pressure applications, wherein the filter is highly efficient in metals, chlorine, or other contaminant removal, because of more complete usage of the media. There is a need for a filter that has a reasonable flow rate with good contaminant removal and a long life before contaminant breakthrough.

### SUMMARY OF THE INVENTION

The present invention relates to methods of improving wetting of filter media, improving flow distribution, and increasing media utilization. The invention comprises a filter/cartridge that has many filter beds or “compartments” of media in parallel, wherein water is preferably delivered to all of the compartments to flow through each compartment under gravity flow or low pressure. Preferred embodiments of the compartmentalized filter cartridge may be installed in a water pitcher or on an inverted-bottle water cooler, for example, between the reservoir holding the unfiltered water and the reservoir/tap that receives and distributes the filtered water to the user.

The present invention comprises a filter designed for more complete utilization of media, compared to conventional filters that are difficult to wet and that, during use, have significant amounts of dry, unused filter media due to channeling of water through the filter media. The inventor suspects that the channeling in these conventional filters takes the form of water flowing substantially down the filter wall rather than flowing in an evenly distributed pattern through-out the filter cross-section. An object of the present invention, therefore, is to provide a filter or filter cartridge constructed to place and maintain the liquid being filtered in contact with more of the media contained in the filter/cartridge, for higher filtration efficiency and longer filter life. Another object of the present invention is to provide such a filter/cartridge that exhibits a good, consistent flow-rate of liquid under gravity-flow and other low pressure conditions. Another objective is to provide a system, wherein, given a media loading, given a media type, and given overall filter dimensions, the multiple-compartment filter's media effectiveness and media life, are improved compared to a conventional single-compartment filter beds in the same outer housing.

The invented filter/cartridge, hereafter called a “filter,” contains media in multiple, parallel-flow compartments, also called “filter beds” or “media beds.” At the inlet of the filter, a portion of the water flows into each of the “compartments” and remains in that compartment preferably the entire way through the filter, with all water preferably flowing together out of the filter below the filter compartments. The inlet of the filter typically includes or is in fluid communication with a gravity-flow reservoir that forms on a grate or pad in of directly above the filter. Flow distribution means may be included to encourage even flow distribution at the filter inlet to all of the compartments, or the reservoir, in effect, may be the filter inlet and may be equal in diameter to the filter in order to encourage even flow distribution.

This “compartmentalized” or “divided” media configuration provides much smaller radial cross-sectional areas of media compared to a conventional single-compartment filter. Also, because each compartment is surrounded and defined by a wall of liquid-impermeable or at least liquid-resistant material, this compartmentalized/divided configuration provides a large amount of wall surface per volume of media in each compartment, and large amount of wall surface per total media volume. Also, this compartmentalized/divided configuration provides a significantly smaller diameter to length ratio for each compartment than in the single compartment filter.

Because the invented filter, in many embodiments, comprises slightly hydrophobic media, liquid flowing through each compartment may still tend to flow out toward, and down along, the compartment wall surface so that there may still be channeling. However, even with some liquid mal-distribution, such as the suspected flowing of the liquid only down the wall or other forms of channeling, the inventor believes that the overall liquid contact with media is improved by the compartmentalized design. The compartments are preferably sized and designed so that the total wall surface area is greater in the multiple-compartment embodiments than in a single-compartment filter, so that, if the liquid flows down the wall of each compartment and contacts the media near the wall, the liquid will contact a higher percentage of the total media. In other words, in the invented filter, a high percentage of the media is at or near a compartment wall, and, therefore, a high percentage of the media is used and effective.

Preferred embodiments include many different designs of compartmentalization, including for example a single unitary member that has many walls and interior spaces or many separate members installed side-by-side in the filter housing. A single unitary member (196, FIG. 12) with many compartments may be made as a separate insert and installed into a filter housing, or the compartmentalized member may be molded integrally with the filter housing. This way, the single unitary member has many parallel conduits/compartments through it, and most or all of the conduits/compartments share conduit/compartment walls. Embodiments with many separate members inserted side-by-side may include, for example, a plurality of tubes such as straw-shaped conduits (186, FIG. 11), or a plurality of hollow, polygon-shaped conduits.

In either case, whether a single multi-walled member is inserted or molded into the housing or many separate conduits are inserted into the housing, all of the available volume inside the conduits is preferably loaded with media. Many different shapes of conduits may be used, for example, a single, extruded or molded member with multiple walls forming rectangular, polygon, or circular conduits may be installed within the housing, wherein media is loaded in all the spaces between multiple walls. If there is space between the conduits, for example, between tubes slid into the housing, the space between the tubes should also be loaded with media, so there is no bypassing of liquid around media.

### BRIEF DESCRIPTION OF THE DRAWINGS

FIG. 1 is a schematic axial cross-sectional view of a prior art water filter under gravity-flow conditions, showing water flow out and down the inner wall surface of the filter housing.

FIG. 2 is a schematic axial cross-sectional view of a water filter under gravity-flow conditions that have two series-flow beds, showing water flow out and down the inner wall surfaces of the filter housing.

FIG. 3A is a schematic axial cross-sectional view of one embodiment of the invented water filter under gravity-flow conditions, showing a plurality of media compartments with small diameters compared to conventional filters, and showing water flow down the compartment wall surfaces.

FIG. 3B is a schematic radial cross-sectional view of the embodiment of FIG. 3A.

FIG. 3C is a schematic enlarged detail of a small portion of the embodiment of FIG. 3A, showing flow down through the small-diameter compartments, including down along the compartment wall surfaces.

FIG. 4 is a schematic radial cross-sectional view of an alternative embodiment of a divided filter bed according to the invention, wherein the compartments are pie-shaped sections of a cylindrical bed.

FIGS. 5-10 are schematic top views of alternative embodiments of divided filter beds according to the invention.

FIG. 11 is a schematic side perspective view of a plurality of tubes that may be inserted into a filter bed and loaded with media inside the tubes and between the tubes, according to one embodiment of the invention.

FIG. 12 is a schematic side perspective view of a single monolithic insert that may be installed in a filter housing, and loaded with media, according to another embodiment of the invention.

FIG. 13 is a schematic side view of a long filter housing with six media compartments shown, according to another embodiment of the invention.

FIG. 14 is a schematic top view of an especially-preferred embodiment of a divided filter bed according to the invention.

### DESCRIPTION OF THE PREFERRED EMBODIMENTS

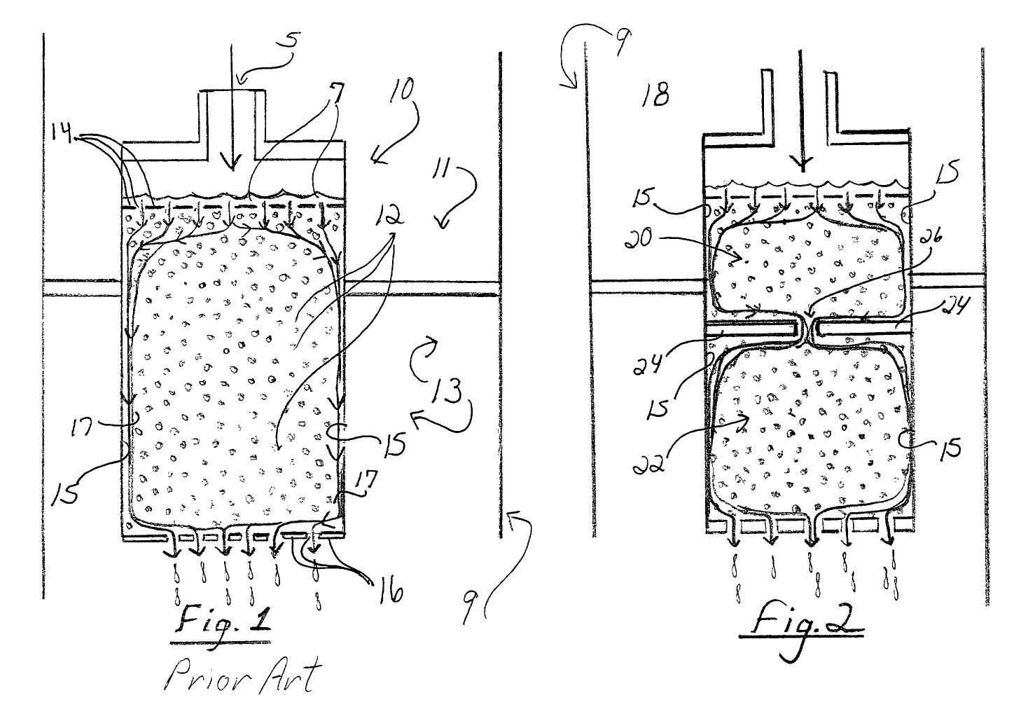

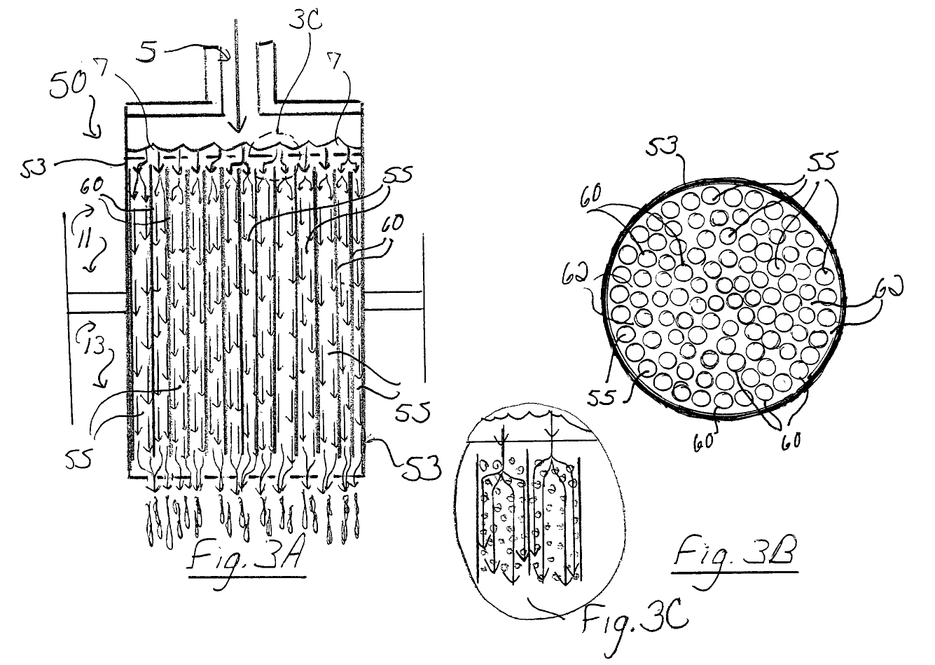

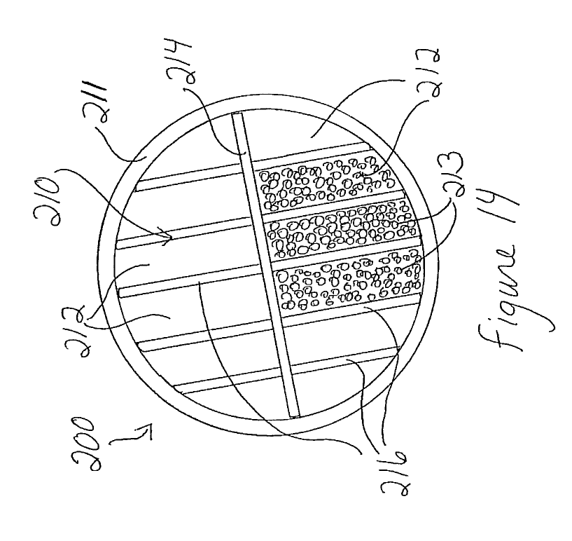

Referring to the Figures, there are shown several, but not the only, embodiments of the invented compartmentalized system for water, beverage, and other liquid filtration and treatment. FIG. 1, there is shown a prior art gravity glow filter with flow lines illustrating the flow distribution or “profile” inside the media, which may be said to feature substantial channeling of the fluid. Referring to FIG. 2, there is shown an attempt to improve the flow profile. Referring FIGS. 3-14, there are shown are embodiments of filters or filter inserts according to the invention.

The preferred, but not the only application, for filters according to the invention are low pressure operations, such as gravity-flow water filtration or other operations at less than about 15 psi. As discussed above, in such low pressure filtration, the main problem is the inability of filters to “wet out,” even after being in service for quite a while. For example, there is not enough pressure in an inverted-bottle style water dispenser, or a home-use water filtration water pitcher, to force the water into contact with all of the media in a conventional filter. Because of this, as discussed above in the Related Art Section, filter media utilization in such conventional filters is poor, due to a poor water flow “profile.” In this poor water flow profile, all the water is believed to flow out and down along the filter housing wall, channeling along the wall area rather than flowing evenly throughout the entire radial cross-section of the filter. The inventor of the present invention believes the media of conventional filter are also only partially wetted-out during use. This translates into the water contacting and being filtered/treated by only a fraction of the media, resulting in the effective media volume being only a fraction of the total loaded media volume. In other words, much of the media remains dry during use, and does not, therefore, contribute to filtration/treatment.

The present inventor has conducted many tests in which media wetting and effectiveness were tested, and has found that conventional filters, even after the recommended pre-wet procedures and after use, contain a large dry “core” of dry, unused filter media at the center of the filter. In this experimentation, the inventor has seen that, in conventional cylindrical filter beds, the liquid flow due, under gravity or low-pressure conditions, is down along the inner wall surface of the filter housing and down through only a thin cylindrical shell of media at/near the inner wall surface. With such a small amount of filter media being used, the filtration effectiveness, as may be measured by removal of metals, chorine, or other contaminants, is low. Further, the resulting filter life is much shorter than the life one would expect from calculations based on total filter media volume and the media's theoretical capacity for adsorbing/holding contaminants. Filter life is defined by the amount of the time the filter does an adequate job of removal of said contaminants or the volume of liquid filtered before contaminants “breakthrough” to unacceptable levels at the filter outlet.

FIG. 1 illustrates a conventional filter 10 in a gravity-flow device 9 such as a water pitcher. In this device, water enters at the filter inlet 5, and lies in a shallow reservoir or pool 7 above a distributor pad or grill 14. From the grill 14, the water flow enters the single filter bed, bypassing most of the media 12, which is a carbon-based media provided in granular form. In FIG. 1, there is shown the filter 10 installed between the upper un-filtered water reservoir 11 and the filtered water reservoir 13. The flow path between the two reservoirs 11, 13 is through the filter 10. The inventor has tried various modifications to the structure of conventional filters, focusing on changing the way in which water is distributed to the filter bed or collected and let out of the filter bed. For example, the inventor has tried modifications to the inlet holes, slots, or grills 14, or the outlet holes, slots or grills 16, but such modifications produced little improvement in flow profile. However, various modifications still produced a flow profile such as is shown in FIG. 1 by the flow arrows downward, but substantially along the single wall surface 15 and a thin shell of media at or near the wall at 15.

The inventor has also produced a filter 18 dividing the filter bed of a conventional filter into two series-flow filter beds 20, 22, with the flow of water between the series-flow beds being carefully controlled. This was done with a disk 24 between the series-flow filter beds having only one hole 26 at its center, so that all water had to flow from the first bed 20 to the center hole 26 of the disk to be redistributed to the second bed 22. This modification also produced a poor flow profile under low pressure (gravity-flow) conditions, as illustrated in FIG. 2, again by flow arrows against/near the single wall.

In the invented filter 50 of FIG. 3A, and the invented methods, a filter is provided in which the single filter housing 53 is divided in many parallel-flow compartments 55 of media. The compartments 55 are liquid-sealed or substantially liquid-sealed from each other by compartment walls 60, so that, once water enters a compartment, that water must flow completely or at least substantially through only that compartment all the way to the outlet of the compartment at the lower end of the filter. A schematic portrayal of such a filter, in axial cross-section, according to the invention is shown in FIG. 3A, and a radial cross-section is shown in FIG. 3B. In the embodiment of FIGS. 3A and 3B, the walls 60 may be formed by the insertion of many tubes into the housing 53, and the media is loaded into the interior space of every tube and also into the spaces 62 between the tubes, to prevent bypass of the media.

Preferably, the compartments are elongated, and many of them exist in a single filter housing. Preferably, there are preferably at least 10 compartments in a filter housing, and preferably many more compartments in the filter housing, so that the water flow is divided into many portions to flow through small-cross-sectional areas. For example, a 4-inch inner-diameter filter housing has an a radial cross-sectional area of about 12.6 square inches, but, if divided into 20 approximately equal compartments, the typical compartment would have a cross-sectional area (perpendicular to the direction of flow) of only about 0.63 square inches per compartment.

If there are 10 compartments, preferably each compartment contains about 1/10 of the total media, or, if there are 20 compartments, preferably each compartment contains about 1/20 of the total media. Likewise, each of the compartments will contain slightly less (accounting for the volume taken up by the walls) than 1/10 and 1/20, respectively, of the total media in a similar filter housing without the compartment walls.

In other words, the invention provides for many more filter beds in a single filter, and each filter bed is a much smaller diameter than the original single-compartment filter. The preferred compartments have only a fraction of the diameter of the filter housing and contain a fraction of the total media. For example, preferred compartments may have diameters of less than about ⅓ the diameter of the filter housing, and, more preferably, less than about ⅕ of the diameter of the filter housing.

While gravity-flow operation in the single-compartment filter housing exhibits very erratic and unpredictable flow-rates, and exhibits poor wet-out and poor filter life, the same filter housing divided into many filter beds exhibits more consistent flow-rate, greatly improved wetting, metals and chemical removal, and filter life. For example, a 4-inch diameter conventional filter, with the large area in a single compartment, loaded with about a 2-inch deep filter bed of a carbon-based metals-removal media (approximately 95 grams of media), produces erratic, flow-rates and poor lead-removal performance. After dividing the single compartment into many compartments (for example, about 100) a slightly less amount of media is loaded into the housing (85 grams rather than 95 grams) both into and between the many tubes that form the compartment walls. This slightly lower amount of media is because of the volume taken up by the compartment walls. This embodiment of the invention produced substantially consistent flow-rates of filtered water by gravity-flow, in the range of about 260-280 ml/minute throughout filtration. The invented filter reduced lead in the water from 1.90 ppm lead to less than 0.05 ppb lead. When media was removed from the filter, substantially all of the media was wet and, hence, judged to be utilized during filtration.

The inventor believes that invented configuration is beneficial because of what may be described as maximizing the “wall-effect” in the low flow-rate and low pressure systems of the invention. The water, in such slightly-hydrophobic-media, low flow-rate, laminar-flow applications, is believed to move down along the wall and, hence, the water contacts only the media close to the wall. In the invented apparatus, in other words, there is not just one wall and one thin shell of water flowing down along the wall and contacting media. Instead, there are many walls and consequently many shells of water moving down along the walls and contacting media on the way. Further, it is believed that due to the fluid dynamics in each compartment (for example, the much lower diameter to length ratio for each of the multiple compartments compared to the single-filter), that a larger percentage of each compartment's media is wetted compared to the percentage in the single compartment that is wetted. Hence, the total volume of media that is wetted and therefore filtering water is greater when there are many walls and many filter bed compartments.

The plurality of compartments are parallel-flow compartments, in that water that enters the filter inlet flows into the many compartments at the same time, and water exiting any one compartment does not flow into any of the other compartments. Preferably, if the compartments are sized and shaped substantially identically, the media type and volume in each compartment is the same, or several media are placed in series in each compartment in the same arrangement in each compartment, so that resistance to flow through each compartment is substantially the same, and good flow distribution is maintained. Preferably, if the size or shape of the compartments are different, the media may be loaded to compensate for these differences, again with the goal of equal resistance to flow and good flow distribution. There may be a distribution system, such as pad(s) or grid(s) upstream of the parallel compartments, that effectively provides water to all of the compartments, and such a distributor system is within the skill of one familiar with filter art after seeing this application and these drawings. Also, there maybe a pre-filter bed(s) upstream of the parallel compartments or other filtration or treatment. Likewise, there may be a post-filter(s), pad, or grid underneath the parallel compartments. This way, the plurality of parallel compartments may be said to be in series-flow with pad(s), grid(s), or filter bed(s) upstream and/or downstream of the parallel compartments. In the preferred gravity flow, low-pressure embodiments, however, any pre-filters or post-filters that are not divided into multiple compartments may suffer from channeling or wetting problems, depending upon the media.

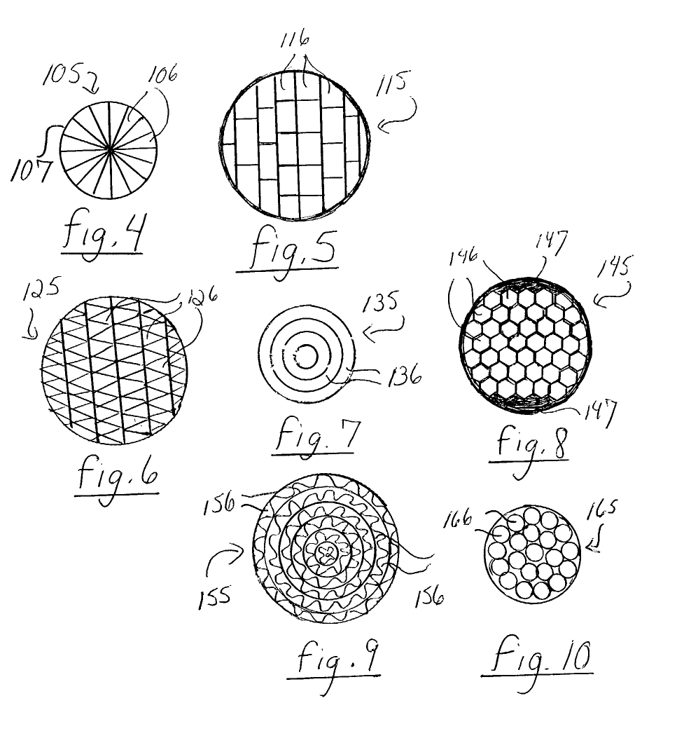

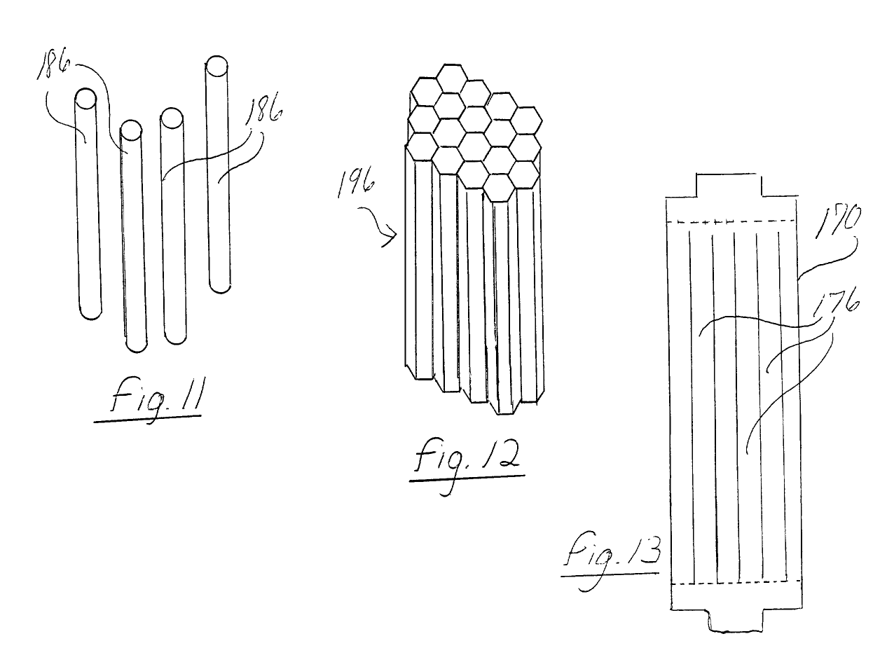

Alternative embodiments of compartmentalized filters are shown schematically in FIGS. 4-10. FIG. 4 illustrates a divided filter bed 105 with walls that extend radially from the center to the outer housing wall 107 to form wedge-shaped compartments 106. FIG. 5 illustrates a divided filter bed 115 with generally rectangular “brick-stacked” compartments 116. FIG. 6 illustrates a divided filter bed 125 with triangular-shaped “corrugate-style” compartments 126. FIG. 7 illustrates a divided filter bed 135 with concentric ring-shaped compartments 136. FIG. 8 illustrates a divided filter bed 145 with polygon-shaped (honey-comb) compartments 146, wherein the darkened sections 147 illustrate that some areas may be blocked-off to liquid flow, if judged to be beneficial for preventing liquid bypass around the media beds. FIG. 9 illustrates a divided filter bed 155 that is made from concentric rings of corrugated-style compartments 156. FIG. 10 illustrates a divided filter bed 165 having 21 tubular compartments 166. Once a designer has seen this Description and Drawings, he/she may design alternative filter bed compartment shapes and numbers, with care given to balancing the beneficial of a high number of compartments effect (increased media-contact efficiency), with the detrimental effect of increased pressure drop that may be caused by too-small compartments, or problems with evenly distributing water to each compartment.

While embodiments with 2-4 compartments, and embodiments with 5-9 compartments, also included in the invention, it is preferred that at least 10 compartments are provided, and, preferably, for “short” filter housings (with low length to diameter ratios if the filter is used as a single compartment) many more compartments are provided. In many embodiments, at least 20 compartments are provided, and the best results for short filter housings are expected when 20-100 are provided, depending on the relative length and radial cross-section of the filter housing. For shorter, large radial-cross-sectional beds, as shown in FIGS. 3A, many compartments are needed. For longer, smaller-diameter filter housings 170 as shown in FIG. 13, fewer compartments are needed, for example, the six compartments 176 shown in the side view of FIG. 13. For example, preferably, compartments are provided to make each filter bed (each compartment) at least 4 times as long as its radial diameter or other width dimension. In some embodiments, compartments are provided to make each filter bed at least 10 times longer than its radial diameter, and, most preferably about 10-20 times longer. For different applications, however, those skilled in the art, after viewing this description and drawings, will find optimum dimensions for compartments based on different media, different liquid composition, and different pressure conditions.

FIG. 14 illustrates an especially-preferred filter 200 according to the invention. This may called a “herring-bone” design, comprising an insert 210 set into a cylindrical filter housing wall 211. Three of the 12 compartments 212 of the filter 200 are shown as having been loaded with media 213, in a process in which the media is preferably loaded into all the compartments after insertion of the insert 210 into the housing. The insert 210 has generally rectangular compartments 212 sharing a central spine wall 214 across the entire diameter of the filter, with multiple ribs 216 extending out perpendicularly from the spine wall 214 all the way to the housing wall 211.

The result of the invented compartmentalization is improved water distribution and media contact. This is especially important in lead-removal applications, were high efficiency is needed to achieve an acceptable filter life. For example, water flowing through a single-compartment filter in a conventional gravity-flow profile, only occupies and contacts, for the sake of example, about 1/10 of the media volume. When the filter is compartmentalized into many compartments, for example 20 or more, water contacts a much higher percentage of the media in each compartment, for example, 50-95 percent of the media in each compartment.

The inventor also believes that an important factor in filter performance according to the invention may be proper air venting. This may be important especially in gravity-flow applications, wherein not all of the media is wet, and a portion of the media may be surrounded by air. Therefore, other components of the preferred embodiments, for example, pre-filters, cyst removal means, or other components for enhancing filtration or providing treatment of the water or other liquid, should be designed to allow good venting of air. One of skill in filter art will understand, after reading this application, ways of providing good venting of air out of the filter during wetting and operation of the invented filter.

The terms “filtration” and “treatment” are used herein, as an indication that various types of processing and media may find benefit in the invented apparatus and methods. For example, removal of metals, chemical, and other contaminants, addition of chemicals and subsequent removal of those chemicals, or addition of flavorings or anti-bacterial agents, and many other liquid treatment processes by be included. Distiller post-filtration is also envisioned by the inventor as an application for the invention. While the invention is particularly useful in applications in which the media is somewhat hydrophobic, the invention is not limited to only such applications.

Although this invention has been described above with reference to particular means, materials and embodiments, it is to be understood that the invention is not limited to these disclosed particulars, but extends instead to all equivalents within the broad scope of the following claims.

I claim:

1. A water filter comprising:
a filter housing having an outer wall, an axial dimension, a radial dimension, an internal space, a filter inlet and a filter outlet in fluid communication with the internal space;
a plurality of internal walls provided in the filter housing extending axially to divide lo said internal space into a plurality of axial compartments that are in fluid communication with the filter inlet and filter outlet;
filtration media contained within each of the plurality of axial compartments;
wherein said axial compartments are adapted to be in parallel-flow arrangement so that water enters the filter inlet, flows to all of said compartments, and from said compartments to the filter outlet.

2. A water filter as in claim 1, wherein the plurality of internal walls are provided as a unitary piece that is inserted into a filter housing.

3. A water filter as in claim 1, wherein the plurality of internals walls are molded integrally with the filter housing outer wall.

4. A water filter as in claim 1, wherein the plurality of internal walls are each tubular.

5. A water filter as in claim 1, wherein the plurality of internal walls comprise straight ribs extending out from a straight spine.

6. A water filter as in claim 1, comprising at least 10 of said axial compartments.

7. A water filter as in claim 1, comprising at least 20 of said axial compartments.

8. A water filter as in claim 1, wherein said filtration media is activated carbon.

9. A water filter as in claim 1, in combination with a gravity flow water container having an upper reservoir for receiving unfiltered water above said water filter and a lower reservoir for receiving filter water, wherein said water filter is supported inbetween, and in fluid communication with, the upper reservoir and the lower reservoir, so that unfiltered water flows into said water filter under gravity, is filtered by the water filter, and then flows under gravity into the lower reservoir.

10. A water filter comprising:
a filter housing having an outer wall, an axial dimension, a radial dimension, an internal space, a filter inlet and a filter outlet for delivering water to and removing water from the filter, respectively, said inlet and outlet being in fluid communication with the internal space;
a plurality of axial internal walls provided in the filter housing and dividing said internal space into at least 5 axial, parallel-flow compartments that are in fluid communication with the filter inlet and filter outlet;
filtration media contained within each of the axial parallel-flow compartments; and
a liquid distribution system adapted so that water entering the water filter is distributed to all of said compartments at the same time for parallel flow through the compartments.

11. A water filter as in claim 10, wherein said internal walls are tubes inserted into the filter housing.

12. A water filter as in claim 10, wherein said internal walls are portions of a single unitary insert into the filter housing.

13. A water filter as in claim 12, wherein said single unitary insert has a spine wall extending all the way across the internal space, and a plurality of rib walls extending perpendicularly from the spine wall.

14. A method of water filtration comprising:
providing a filter housing having a plurality of axially-extending parallel-flow compartments inside the interior space of the filter housing, each compartment containing filter media;
providing water to an inlet of the filter at less than 15 psi pressure, so that the water is distributed to flow into the plurality of compartments in parallel flow before leaving the filter housing.

15. A method as in claim 14, wherein the water flowing through the filter is at gravity flow conditions.

16. A method as in claim 14, wherein said media is granular activated carbon.
